(19) United States
(12) Patent Application Publication
(10) Pub. No.: US 2024/0284235 A1
(43) Pub. Date: Aug. 22, 2024

(54) Method And Apparatus For Network Energy Saving With Spatial Element Adaptation In Mobile Communications

(71) Applicant: MediaTek Inc., Hsinchu City (TW)

(72) Inventor: Chi-Hsuan Hsieh, Hsinchu City (TW)

(21) Appl. No.: 18/391,685

(22) Filed: Dec. 21, 2023

Related U.S. Application Data
(60) Provisional application No. 63/485,573, filed on Feb. 17, 2023.

(51) Int. Cl. H04W 28/02; H04B 7/06; H04W 24/10

(52) U.S. Cl. CPC H04W 28/0221; H04B 7/0626; H04W 24/10

(57) ABSTRACT

Examples pertaining to network energy saving with spatial element adaptation in mobile communications are described. A user equipment (UE) transmits a first measurement report of a channel state information-reference signal (CSI-RS) based on a first indication from the network apparatus, and transmits a second measurement report of the CSI-RS based on a second indication from the network apparatus. A number of antenna elements of the network apparatus associated with the first measurement report is less than a number of antenna elements of the network apparatus associated with the second measurement report.

### CROSS REFERENCE TO RELATED PATENT APPLICATION(S)

The present disclosure is part of a non-provisional application claiming the priority benefit of U.S. Patent Application No. 63/485,573, filed 17 Feb. 2023, the content of which herein being incorporated by reference in its entirety.

### TECHNICAL FIELD

The present disclosure is generally related to mobile communications and, more particularly, to network energy saving techniques in spatial domain with spatial element adaptation with respect to user equipment and network apparatus in mobile communications.

### BACKGROUND

Unless otherwise indicated herein, approaches described in this section are not prior art to the claims listed below and are not admitted as prior art by inclusion in this section.

The fifth-generation (5G) network, despite its enhanced energy efficiency in bits per Joule (e.g., 417% more efficiency than a 4G network) due to its larger bandwidth and better spatial multiplexing capabilities, may consume over 140% more energy than a 4G network. Therefore, it is important to achieve 5G network power savings. There are many conflicts among performance metrics. For example, quality of service (QoS), which may be affected by channel assessment accuracy, and power savings may need a tradeoff.

Considering of this, how to achieve network power saving while maintaining channel assessment accuracy becomes an important issue for the newly developed wireless communication network. Therefore, there is a need to provide proper schemes for network power saving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to network energy saving with respect to a communication apparatus (e.g., a user equipment (UE)) and network apparatus (e.g., a network node or a base station (BS), such as a next generation Node B (gNB)) in mobile communications.

In one aspect, a method may involve a processor of a communication apparatus transmitting a first measurement report of a channel state information-reference signal (CSI-RS) based on a first indication from a network apparatus and transmitting a second measurement report of the CSI-RS based on a second indication from the network apparatus. A number of antenna elements of the network apparatus associated with the first measurement report is less than a number of antenna elements of the network apparatus associated with the second measurement report.

In one aspect, a communication apparatus may involve a transceiver which, during operation, wirelessly communicates with at least one network apparatus. The communication apparatus may also involve a processor communicatively coupled to the transceiver such that, during operation, the processor performs following operations: transmitting, via the transceiver, a first measurement report of a CSI-RS based on a first indication from the network apparatus; and transmitting, via the transceiver, a second measurement report of the CSI-RS based on a second indication from the network apparatus. A number of antenna elements of the network apparatus associated with the first measurement report is less than a number of antenna elements of the network apparatus associated with the second measurement report.

In one aspect, a method may involve a processor of a network apparatus performing a spatial domain adaptation by disabling at least one of a plurality of antenna elements of the network apparatus and enabling all of the antenna elements of the network apparatus in a dynamic or a semi-static manner.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of 32 ports CSI-RS configuration under schemes in accordance with implementations of the present disclosure.

FIG. 2 is a diagram depicting an example scenario of type 1 spatial domain adaptation under schemes in accordance with implementations of the present disclosure.

FIG. 3 illustrates an example scenario of type 2 spatial domain adaptation under schemes in accordance with implementations of the present disclosure.

FIG. 4 is a diagram depicting an example communication system having an example communication apparatus and an example network apparatus in accordance with an implementation of the present disclosure.

FIG. 5 is a diagram depicting an example process in accordance with an implementation of the present disclosure.

FIG. 6 is a diagram depicting another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to spatial element adaptation (spatial domain (SD) adaptation, antenna element adaptation or antenna port adaptation) for network energy saving (or network power saving) in mobile communications. According to the present disclosure, a number of possible solutions may be implemented separately or jointly. That is, although these possible solutions may be described below separately, two or more of these possible solutions may be implemented in one combination or another.

An antenna architecture typically may have a plurality of physical antennas and the number of physical antennas may be greater than the number of transceivers. This means that each transceiver may comprise multiple physical antennas. Logical antenna ports may be specified rather than physical antennas in 3^{rd} Generation Partnership Project (3GPP) Specifications. Specific transmissions may use specific antenna ports which are mapped onto one or more physical antennas.

In addition, the 5G New Radio (NR) may support the long-term channel measurements. The UE may derive long-term channel quality indicator (CQ), layer 1 signal to interference plus noise ratio (L1-SINR), or L1-reference signal received power (RSRP) values by measuring multiple synchronization signal block (SSB) or channel state information-reference signal (CSI-RS) occasions. The number of SSBs or CSI-RSs may be determined based on the UE implementation.

In some implementations, the network apparatus with an antenna architecture may have a plurality of physical antennas which associates with a plurality of antenna ports. The network apparatus may perform spatial elements (e.g., the antenna element, such as the physical antennas or the antenna ports) adaptation (e.g., muting or unmuting one or more physical antennas or one or more antenna ports, or, enabling or disabling one or more physical antennas or one or more antenna ports) in a dynamic or semi-static manner.

In some implementations, to achieve spatial element adaptation for network energy saving, the network apparatus may update the configuration of number of ports (e.g., the information element (IE) nrofPorts in the radio resource control (RRC) resource mapping configuration: CSI-RS-ResourceMapping). In some implementations, the network apparatus may update the configuration in a dynamic or semi-static manner based on indication of downlink control information (DCI) or a media access control (MAC) control element (MAC-CE) or RRC configuration.

In some implementations, the network apparatus may save energy more efficiently with a cell-wise spatial element adaptation. In some implementations, the network apparatus may indicate a cell-wise parameter, such as “maximum number of ports”. For example, the parameter may be indicated through a paging signal, or a paging early indication (PEI), or a system information block (SIB) based (SIB-based) signal.

In some implementations, the network apparatus may apply the indicated parameter “maximum number of ports” to a CSI-RS resource configuration. In some implementations, to apply the indicated “maximum number of ports” to a CSI-RS resource configuration, the IE nrofPorts under CSI-RS-ResourceMapping may be configured as a list. The maximum value smaller or equal to the indicated “maximum number of ports” may apply for this CSI-RS resource configuration. For example, in an event that the IE nrofPorts is configured as {8, 16, 32}, and the indicated “maximum number of ports” is set to 10, then the configuration 8 of the IE nrofPorts becomes effective instead of 32.

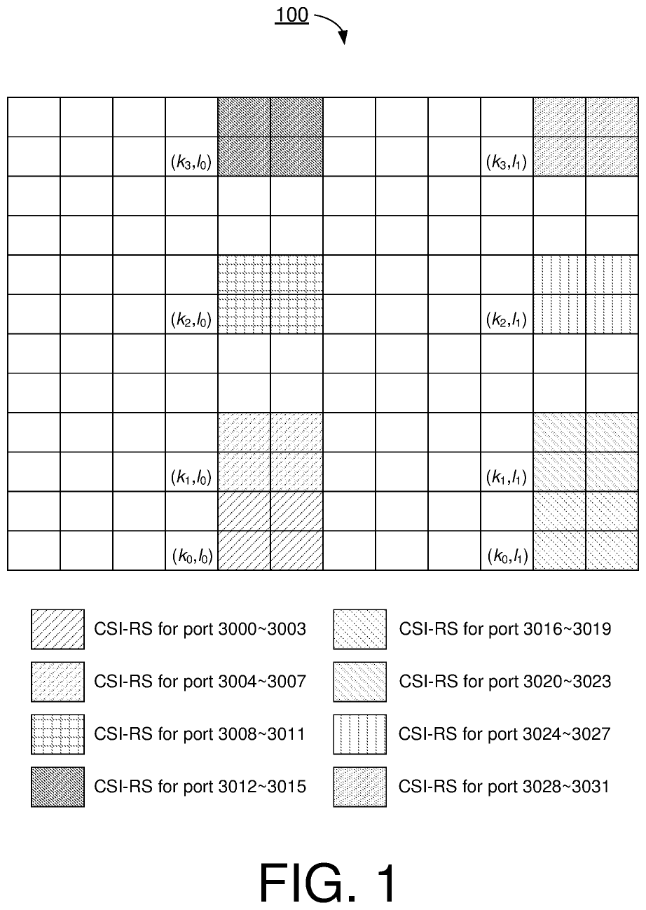

FIG. 1 illustrates an example scenario 100 of 32 ports CSI-RS configuration under schemes in accordance with implementations of the present disclosure. In some implementations, when the number of antenna ports are reduced (e.g., by disabling or muting) due to the antenna ports adaptation (which may be regarded as one type of antenna element adaptation or spatial element adaptation, or the aforementioned SD adaptation), for example, from 32 antenna ports to 8 antenna ports, the selection of subset antenna ports may be defined (e.g., which 8 or 24 antenna ports from the 32 antenna ports are to be enabled (or kept) or disabled (or muted)).

In some implementations, for each element defined in the list of the IE nrofPorts, which subset of antenna ports are to be enabled or disabled may be defined. In addition, for each element in the list of the IE nrofPorts, how other impacted CSI-RS configuration parameters are to be changed (or not) may be further defined. For example, the parameter nrOfAntennaPorts (which defines the codebook-subset restriction) under the configuration CodebookConfig under the RRC configuration CSI-ReportConfig may be different for different elements (values) in the list of the IE nrofPorts.

In some implementations, the network apparatus may determine an enabled or disabled status (e.g., the corresponding spatial adaptation pattern) of a plurality of antenna ports for one or more antenna port subsets in a type 1 implementation of spatial element adaptation (antenna element adaptation) and transmit a report configuration (e.g., the RRC configuration CSI-ReportConfig) to the communication apparatus. The report configuration may comprise a list of sub-configurations, which may be provided by a higher layer parameter. That is, one report configuration may contain multiple CSI report sub-configurations. Each sub-configuration may be identified by a sub-configuration ID and may correspond to one antenna port subset (or, correspond to one spatial adaptation pattern or one or more CSI-RS resources).

In some implementations, the network apparatus may determine the spatial adaptation pattern(s) (for example, determine the number of antenna ports to be enabled or disabled or which antenna ports are to be enabled or disabled) based on one or more previous CSI measurement reports received from the communication apparatus, the cell loading of the network apparatus, the power saving mechanism or algorithm of the network apparatus, or any determination rules defined by the network apparatus.

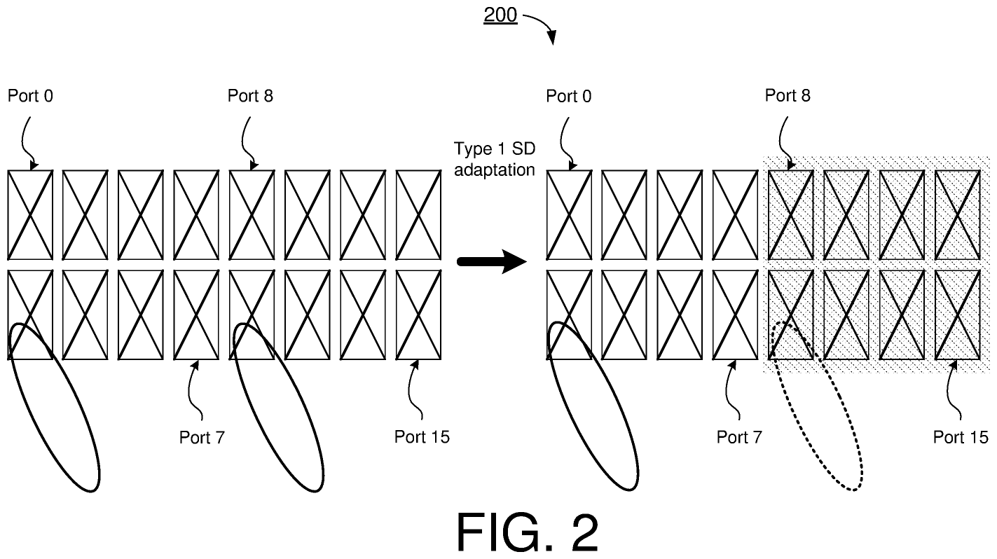

FIG. 2 illustrates an example scenario 200 of type 1 SD adaptation under schemes in accordance with implementations of the present disclosure. In FIG. 2, an example of type 1 spatial adaptation pattern is shown, which may also be regarded as an antenna port subset in which the antenna ports 8-15 are disabled (muted) by the network apparatus. In this embodiment, the status of the antenna ports 0-7 are enabled, and the status of the antenna ports 8-15 are changed from an enabled status to a disabled status after the antenna element adaptation is applied for implementing network energy saving in spatial domain.

In some implementations, the network apparatus may determine an enabled or disabled status (e.g., the corresponding spatial adaptation pattern) of a plurality of physical antennas in a type 2 implementation of spatial element adaptation (antenna element adaptation) and transmit a report configuration (e.g., the RRC configuration CSI-ReportConfig) to the communication apparatus.

In some implementations, the network apparatus may determine the spatial adaptation pattern(s) (e.g., determine the number of physical antennas in one antenna port to be enabled or disabled or which physical antennas in one antenna port are to be enabled or disabled) based on one or more previous CSI measurement reports received from the communication apparatus, the cell loading of the network apparatus, the power saving mechanism or algorithm of the network apparatus, or any determination rules defined by the network apparatus.

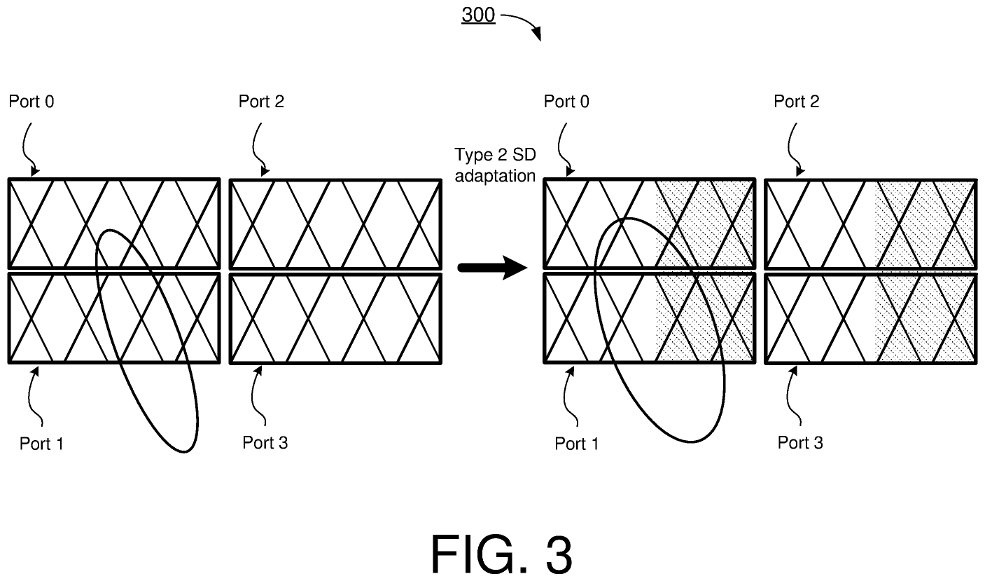

FIG. 3 illustrates an example scenario 300 of type 2 SD adaptation under schemes in accordance with implementations of the present disclosure. In FIG. 3, an example of type 2 spatial adaptation pattern is shown. In this embodiment, after the antenna element adaptation is applied for implementing network energy saving in spatial domain, half of the physical antennas in each antenna port are enabled and the other half of the physical antennas in each antenna port are changed from an enabled status to a disabled status.

In some implementations, for the communication apparatus wirelessly communicates with the network apparatus, the communication apparatus may receive the aforementioned report configuration from the network apparatus. The report configuration may comprise the list of sub-configurations. Each sub-configuration may be identified by a sub-configuration ID, and may correspond to one antenna port subset (or, correspond to one spatial adaptation pattern or one or more CSI-RS resources).

In some implementations, the report configuration may be transmitted by the network apparatus (as well as received by the communication apparatus) through an RRC signaling.

In some implementations, the communication apparatus may measure the CSI-RS based on the report configuration, generate a measurement report of the CSI-RS according to a result of the measuring of the CSI-RS and transmit the measurement report of the CSI-RS based on the report configuration.

In some implementations, an additional bitmap in RRC configuration may be used for the selection of subset of antenna ports to be disabled or enabled (i.e., to be muted or kept). In some implementations, each sub-configuration may comprise a bitmap parameter. Each sub-configuration may be configured with an antenna port subset using the higher layer bitmap parameter. The bitmap parameter may comprise a bit sequence, such as the bit sequence p₀, p₁, . . . , p_{P-1}, where p₀ is the most significant bit (MSB) and p_{Pm-1} is the least significant bit (LSB). Each bit in the bit sequence may correspond to at least one antenna port. As an example, the bit pᵢ corresponds to antenna port 3000+i, and Pm is the number of ports IE nrofPorts configured for the CSI-RS resources(s) within a non-zero power (NZP) CSI-RS resource set which may be contained in a CSI resource configuration for channel measurement that corresponds to the report configuration (e.g., the RRC configuration CSI-ReportConfig).

For example, based on the port configuration shown in FIG. 1, when antenna port number is adapted from 32 to 8, a 32-bit bitmap of “11111111000000000000000000000000” may indicate that the ports 3000˜3007 are kept and the ports 3008˜3031 are muted.

In some implementations, a predefined bit value of the bit in the bit sequence may indicate that the corresponding antenna port is disabled for the corresponding sub-configuration. For example, as in the 32-bit bitmap example provided above, the bit value 0 may indicate that the corresponding antenna port is disabled for the sub-configuration, whereas the bit value 1 may indicate that the corresponding antenna port is enabled and belongs to the antenna port subset for the sub-configuration.

In some implementations, the list of sub-configurations may be provided to the communication apparatus through the report configuration (e.g., the RRC configuration CSI-ReportConfig) before the selection of one antenna port subset for implementing the spatial element adaptation.

In some implementations, each sub-configuration may comprise an indication of codebook subset restriction corresponding to the antenna ports, for example, N1, N2, and Ng (multi-panel case).

In addition to using a bitmap, in some implementations, for the selection of subset of antenna ports to be disabled or enabled (i.e., to be muted or kept), an RRC configured or pre-defined table may be used to define which antenna ports are to be disabled or enabled, based on the chosen of the IE nrofPorts corresponding to indicated parameter “maximum number of ports” mentioned above. An additional muting indication may be transmitted by DCI or MAC-CE to specify which muting setting would be applied.

As an example, based on the port configuration shown in FIG. 1, the muting indication ‘00’ specifies that port 3000˜3007 are enabled (kept), the muting indication ‘01’ specifies that port 3008˜3015 are enabled (kept), the muting indication ‘10’ specifies that port 3016˜3023 are enabled (kept), and the muting indication ‘11’ specifies that port 3024˜3031 are enabled (kept).

In some implementations, the communication apparatus may report N CSI(s) in one reporting instance where N CSI(s) are from L sub-configuration(s), and where N and L are positive integers and 1≤N≤L.

In addition to using a bitmap or a configured or pre-defined table, in some implementations, for the selection of subset of antenna ports to be disabled or enabled (i.e., to be muted or kept), a pre-defined rule may be used to determine which antenna are to be disabled or enabled. For example, to adapt antenna port number from 32 to 8, two possible pre-defined rules are listed below: (1) The corresponding 8 antennas with the lowest port index are kept, and (2) The corresponding 8 antennas with the highest port index are kept.

In some implementations, for the definition of how other impacted CSI-RS configuration parameters are to be changed, similar approaches may be applied, including: (1) an RRC based indication (e.g., using a bitmap), (2) an RRC configured or pre-defined table with additional indication by DCI or MAC-CE, and (3) using one or more pre-defined rules.

On top of spatial element adaptation (or, antenna element adaptation) with at least one antenna element being muted or disabled, it is also important that the network apparatus is able to obtain sufficient information (e.g., sufficient CSI measurement reports) to determine when to turn on the muted or disabled antenna elements, based on the channel condition of different number of antenna elements. Therefore, in some implementations, the network apparatus may occasionally transmit the CSI-RS without any antenna element being muted or disabled, so that the communication apparatus is able to measure a complete CSI report to assist the network apparatus to assess whether or when to turn on the muted or disabled antenna elements. Note that in accordance with different implementations of the present disclosure, an antenna element may be an antenna port or a physical antenna (e.g., one physical antenna configured in an antenna port).

In some implementations, the network apparatus may perform a spatial domain adaptation by disabling at least one of a plurality of antenna elements of the network apparatus. The spatial domain adaptation may be either a type 1 spatial domain adaptation or a type 2 spatial domain adaptation. In some implementations, the network apparatus may stop/suspend the spatial domain adaptation and enable all of the antenna elements in a dynamic or a semi-static manner. For example, in an implementation of type 1 spatial domain adaptation, the network apparatus may enable all antenna ports to support a full antenna port transmission. For example, in an implementation of type 2 spatial domain adaptation, the network apparatus may enable all physical antennas in the antenna ports to support a full antenna transmission.

In some implementations, the network apparatus may determine an enabled or disabled status of the antenna elements for one or more spatial adaptation patterns, such as but not limited to, one or more antenna port subsets. The network apparatus may transmit a first configuration to the communication apparatus. In some implementations, the first configuration may comprise a list of sub-configurations, and each sub-configuration may correspond to one spatial adaptation pattern. In some implementations, the network apparatus may transmit a first indication to select one or more sub-configurations to the communication apparatus via a DCI or a MAC-CE.

In some implementations, the network apparatus may define a specific spatial adaptation pattern in which all of the antenna elements are enabled. For example, in an implementation of type 1 spatial domain adaptation, the network apparatus may define a specific spatial adaptation pattern in which all of the antenna ports are enabled, and the list of sub-configurations may comprise a specific sub-configuration corresponding to the specific spatial adaptation pattern (as well as corresponding to a specific antenna port subset which indicates an all-enabled status of the antenna ports). For another example, in an implementation of type 2 spatial domain adaptation, the network apparatus may define a specific spatial adaptation pattern in which all of the physical antennas in the antenna ports are enabled.

In some implementations, when the list of sub-configurations comprises the specific sub-configuration with the specific spatial adaptation pattern in which all of the antenna elements are enabled, the network apparatus may transmit a second indication to select the specific sub-configuration to the communication apparatus via the DCI or the MAC-CE.

In some implementations, instead of transmitting an indication to select the specific sub-configuration, the network apparatus may transmit an indication to the communication apparatus to indicate an all-enabled status of the antenna elements via the DCI or the MAC-CE.

In some implementations, the network apparatus may transmit an indication to the communication apparatus to indicate an all-enabled status of the antenna elements via a paging signal, a PEI, or a SIB-based signal.

In some implementations, the network apparatus may transmit a second configuration to the communication apparatus. The second configuration may comprise information regarding a period or one or more occasions to enable all of the antenna elements. In such implementations, the network apparatus may perform a CSI-RS transmission based on the second configuration. For example, the network apparatus may perform the CSI-RS transmission by using all of the antenna elements at the time implicitly or explicitly indicated by the period or the occasions specified in the second configuration.

In some implementations, the network apparatus may receive the measurement report of the CSI-RS from the communication apparatus and determine whether to change an enabled or disabled status of the antenna elements of the spatial domain adaptation based on the measurement report. As an example, the network apparatus may assess whether or when to turn on the muted or disabled antenna elements based on the measurement report.

In some implementations, the communication apparatus may transmit a first measurement report of CSI-RS based on a first indication from the network apparatus, and transmit a second measurement report of the CSI-RS based on a second indication from the network apparatus. In some implementations, a number of antenna elements of the network apparatus associated with the first measurement report is less than a number of antenna elements of the network apparatus associated with the second measurement report. In some implementations, the transmitting of the second measurement report may be triggered in a dynamic or a semi-static manner.

In some implementations, the communication apparatus may receive a first configuration from the network apparatus. The first configuration may comprise a list of sub-configurations, and each sub-configuration may indicate one or more enabled or disabled antenna elements of the network apparatus. The communication apparatus may receive the first indication to select one or more sub-configurations via a DCI or a MAC-CE.

In some implementations, the communication apparatus may measure the CSI-RS based on said one or more sub-configurations, wherein the measuring of the CSI-RS associated with said one or more disabled antenna elements indicated in said one or more sub-configurations is not performed. The communication apparatus may generate the first measurement report of the CSI-RS according to a result of the measuring of the CSI-RS.

In some implementations, the list of sub-configurations comprises a specific sub-configuration which indicates that all antenna elements of the network apparatus are enabled. The communication apparatus may receive the second indication to select the specific sub-configuration via the DCI or the MAC-CE and measure the CSI-RS based on the specific sub-configuration. The measuring of the CSI-RS associated with all antenna elements are performed. The communication apparatus may generate the second measurement report of the CSI-RS according to a result of the measuring of the CSI-RS.

In some implementations, the communication apparatus may receive the second indication to indicate an all-enabled status of the antenna elements via the DCI or the MAC-CE and measure the CSI-RS based on the second indication. The measuring of the CSI-RS associated with all antenna elements are performed. The communication apparatus may generate the second measurement report of the CSI-RS according to a result of the measuring of the CSI-RS.

In some implementations, the communication apparatus may receive the second indication to indicate an all-enabled status of the antenna elements via a paging signal, a PEI or a SIB-based signal and measure the CSI-RS based on the second indication. The measuring of the CSI-RS associated with all antenna elements are performed. The communication apparatus may generate the second measurement report of the CSI-RS according to a result of the measuring of the CSI-RS.

In some implementations, the communication apparatus may receive a second configuration from the network apparatus. The second configuration comprises information regarding a period or one or more occasions for enabling all antenna elements of the network apparatus, and the second indication is indicated with the second configuration. The communication apparatus may measure the CSI-RS based on the second configuration. The measuring of the CSI-RS associated with all antenna elements are performed. The communication apparatus may generate the second measurement report of the CSI-RS according to a result of the measuring of the CSI-RS.

### Illustrative Implementations

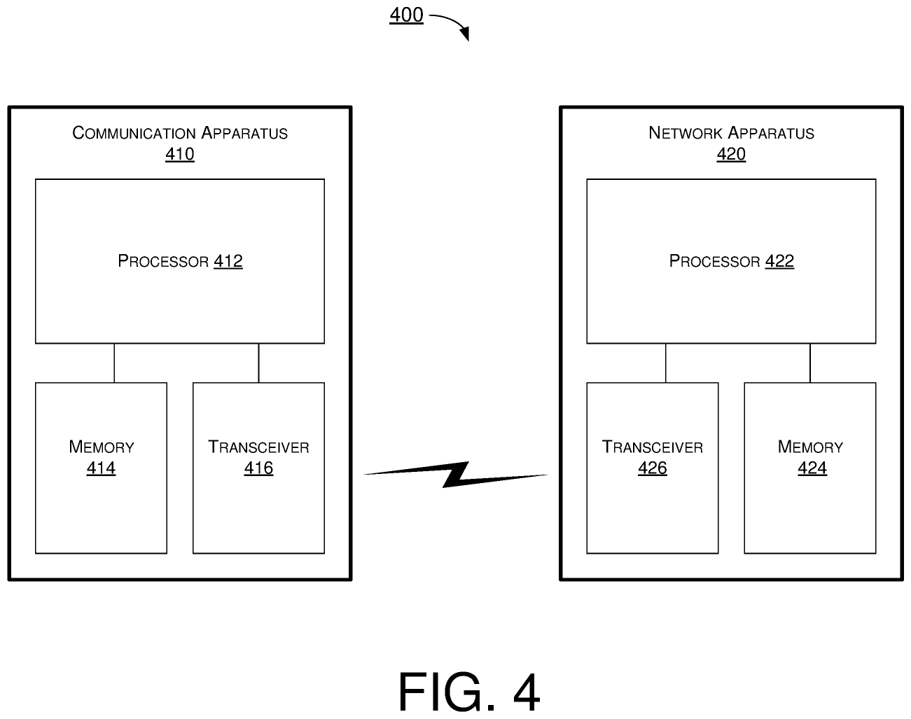

FIG. 4 illustrates an example communication system 400 having an example communication apparatus 410 and an example network apparatus 420 in accordance with an implementation of the present disclosure. Each of the communication apparatus 410 and the network apparatus 420 may perform various functions to implement schemes, techniques, processes and methods described herein pertaining to network power or energy saving with respect to user equipment and network apparatus in mobile communications, including scenarios/schemes described above as well as the process 500 and the process 600 described below.

The communication apparatus 410 may be a part of an electronic apparatus, which may be a UE such as a portable or mobile apparatus, a wearable apparatus, a wireless communication apparatus or a computing apparatus. For instance, the communication apparatus 410 may be implemented in a smartphone, a smartwatch, a personal digital assistant, a digital camera, or a computing equipment such as a tablet computer, a laptop computer or a notebook computer. The communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 410 may be implemented in a smart thermostat, a smart fridge, a smart door lock, a wireless speaker or a home control center. Alternatively, the communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 410 may include at least some of those components shown in FIG. 4 such as a processor 412, for example. The communication apparatus 410 may further include one or more other components not pertinent to the proposed scheme of the present disclosure (e.g., internal power supply, display device and/or user interface device), and, thus, such component(s) of the communication apparatus 410 are neither shown in FIG. 4 nor described below in the interest of simplicity and brevity.

The network apparatus 420 may be a part of a network device, which may be a network node such as a satellite, a base station, a small cell, a router or a gateway. For instance, the network apparatus 420 may be implemented in an eNodeB in an LTE network, in a gNB in a 5G/NR, IoT, NB-IoT or IIoT network or in a satellite or base station in a 6G network. Alternatively, the network apparatus 420 may be implemented in the form of one or more IC chips such as, for example and without limitation, one or more single-core processors, one or more multi-core processors, or one or more RISC or CISC processors. The network apparatus 420 may include at least some of those components shown in FIG. 4 such as a processor 422, for example. The network apparatus 420 may further include one or more other components not pertinent to the proposed scheme of the present disclosure (e.g., internal power supply, display device and/or user interface device), and, thus, such component(s) of the network apparatus 420 are neither shown in FIG. 4 nor described below in the interest of simplicity and brevity.

In one aspect, each of the processor 412 and the processor 422 may be implemented in the form of one or more single-core processors, one or more multi-core processors, or one or more CISC processors. That is, even though a singular term “a processor” is used herein to refer to the processor 412 and the processor 422, each of the processor 412 and the processor 422 may include multiple processors in some implementations and a single processor in other implementations in accordance with the present disclosure. In another aspect, each of the processor 412 and the processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and the processor 422 is a special-purpose machine specifically designed, arranged and configured to perform specific tasks including autonomous reliability enhancements in a device (e.g., as represented by the communication apparatus 410) and a network (e.g., as represented by the network apparatus 420) in accordance with various implementations of the present disclosure.

In some implementations, the communication apparatus 410 may also include a transceiver 416 coupled to the processor 412 and capable of wirelessly transmitting and receiving data. In some implementations, the communication apparatus 410 may further include a memory 414 coupled to the processor 412 and capable of being accessed by the processor 412 and storing data therein. In some implementations, the network apparatus 420 may also include a transceiver 426 coupled to the processor 422 and capable of wirelessly transmitting and receiving data. In some implementations, the network apparatus 420 may have a plurality of physical antennas which associates with a plurality of antenna ports. In some implementations, the network apparatus 420 may further include a memory 424 coupled to processor 422 and capable of being accessed by the processor 422 and storing data therein. Accordingly, the communication apparatus 410 and the network apparatus 420 may wirelessly communicate with each other via the transceiver 416 and the transceiver 426, respectively. To aid better understanding, the following description of the operations, functionalities and capabilities of each of the communication apparatus 410 and the network apparatus 420 is provided in the context of a mobile communication environment in which the communication apparatus 410 is implemented in or as a communication apparatus or a UE and the network apparatus 420 is implemented in or as a network node or a network device of a communication network.

In some implementations, the processor 412 of the communication apparatus 410 may transmit a first measurement report of a CSI-RS via the transceiver 416 based on a first indication from the network apparatus 420. The processor 412 may further transmit a second measurement report of the CSI-RS via the transceiver 416 based on a second indication from the network apparatus 420. A number of antenna elements of the network apparatus 420 associated with the first measurement report is less than a number of antenna elements of the network apparatus 420 associated with the second measurement report.

In some implementations, the processor 412 may receive a first configuration from the network apparatus 420 via the transceiver 416. The first configuration may comprise a list of sub-configurations, and each sub-configuration indicates one or more enabled or disabled antenna elements of the network apparatus. The processor 412 may receive the first indication to select one or more sub-configurations via a DCI or a MAC-CE. The processor 412 may measure the CSI-RS based on said one or more sub-configurations. The measuring of the CSI-RS associated with said one or more disabled antenna elements indicated in said one or more sub-configurations is not performed. The processor 412 may generate the first measurement report of the CSI-RS according to a result of the measuring of the CSI-RS.

In some implementations, the list of sub-configurations may comprise a specific sub-configuration which indicates that all antenna elements of the network apparatus are enabled. The processor 412 may receive the second indication to select the specific sub-configuration via the DCI or the MAC-CE. The processor 412 may measure the CSI-RS based on the specific sub-configuration. The measuring of the CSI-RS associated with all antenna elements are performed. The processor 412 may generate the second measurement report of the CSI-RS according to a result of the measuring of the CSI-RS.

In some implementations, the processor 412 may receive the second indication to indicate an all-enabled status of the antenna elements via the DCI or the MAC-CE. The processor 412 may measure the CSI-RS based on the second indication and generate the second measurement report of the CSI-RS according to a result of the measuring of the CSI-RS. The measuring of the CSI-RS associated with all antenna elements are performed.

In some implementations, the processor 412 may receive the second indication to indicate an all-enabled status of the antenna elements via a paging signal, a PEI, or a SIB-based signal. The processor 412 may measure the CSI-RS based on the second indication and generate the second measurement report of the CSI-RS according to a result of the measuring of the CSI-RS. The measuring of the CSI-RS associated with all antenna elements are performed.

In some implementations, the processor 412 may receive a second configuration from the network apparatus 420. The second configuration comprises information regarding a period or one or more occasions for enabling all antenna elements of the network apparatus, and the second indication is indicated with the second configuration. The processor 412 may measure the CSI-RS based on the second configuration and generate the second measurement report of the CSI-RS according to a result of the measuring of the CSI-RS. The measuring of the CSI-RS associated with all antenna elements are performed.

In some implementations, the processor 422 of the network apparatus 420 may perform a spatial domain adaptation by disabling at least one of a plurality of antenna elements of the network apparatus 420, and enable all of the antenna elements of the network apparatus in a dynamic or a semi-static manner.

In some implementations, the processor 422 may determine an enabled or disabled status of the antenna elements for one or more spatial adaptation patterns, and transmit a first configuration to the communication apparatus 410. The first configuration may comprise a list of sub-configurations, and each sub-configuration corresponds to one spatial adaptation pattern. The processor 422 may transmit a first indication to select one or more sub-configurations to the communication apparatus 410 via a DCI or a MAC-CE.

In some implementations, the list of sub-configurations comprises a specific sub-configuration with a specific spatial adaptation pattern in which all of the antenna elements are enabled. The processor 422 may transmit a second indication to select the specific sub-configuration to the communication apparatus 410 via the DCI or the MAC-CE.

In some implementations, the processor 422 may transmit an indication to the communication apparatus 410 to indicate an all-enabled status of the antenna elements via the DCI or the MAC-CE.

In some implementations, the processor 422 may transmit an indication to the communication apparatus 410 to indicate an all-enabled status of the antenna elements via a paging signal, a PEI or a SIB-based signal.

In some implementations, the processor 422 may transmit a second configuration to a communication apparatus and performing a CSI-RS transmission based on the second configuration. The second configuration comprises information regarding a period or one or more occasions to enable all of the antenna elements.

In some implementations, the processor 422 may receive a measurement report of a CSI-RS from the communication apparatus 410 and determine whether to change an enabled or disabled status of the antenna elements of the spatial domain adaptation based on the measurement report.

### Illustrative Processes

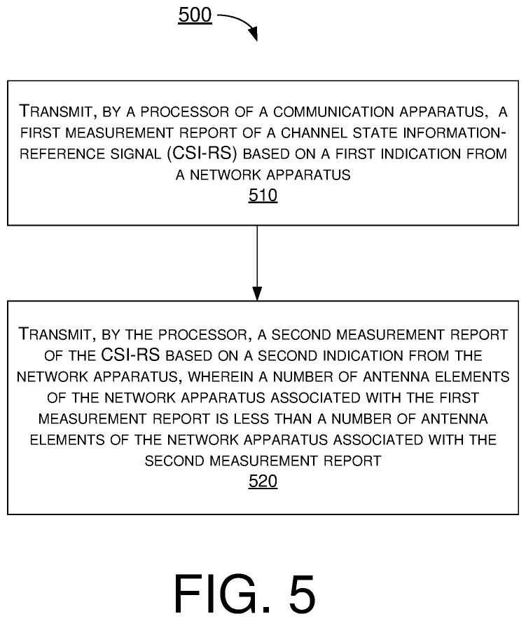

FIG. 5 illustrates an example process 500 in accordance with an implementation of the present disclosure. The process 500 may be an example implementation of above scenarios/schemes, whether partially or completely, with respect to network power saving with spatial element adaptation with the present disclosure. The process 500 may represent an aspect of implementation of features of the communication apparatus 410. The process 500 may include one or more operations, actions, or functions as illustrated by one or more of blocks 510 and 520. Although illustrated as discrete blocks, various blocks of the process 500 may be divided into additional blocks, combined into fewer blocks, or eliminated, depending on the desired implementation. Moreover, the blocks of the process 500 may be executed in the order shown in FIG. 5 or, alternatively, in a different order. The process 500 may be implemented by the communication apparatus 410 or any suitable UE or machine type devices. Solely for illustrative purposes and without limitation, the process 500 is described below in the context of the communication apparatus 410. The process 500 may begin at block 510.

At 510, the process 500 may involve the processor 412 of the communication apparatus 410 transmitting a first measurement report of a CSI-RS based on a first indication from the network apparatus 420. The process 500 may proceed from 510 to 520.

At 520, the process 500 may involve the processor 412 transmitting a second measurement report of the CSI-RS based on a second indication from the network apparatus 420. A number of antenna elements of the network apparatus 420 associated with the first measurement report is less than a number of antenna elements of the network apparatus 420 associated with the second measurement report.

In some implementations, the process 500 may involve the processor 412 receiving a first configuration from the network apparatus. The first configuration may comprise a list of sub-configurations, and each sub-configuration indicates one or more enabled or disabled antenna elements of the network apparatus. The process 500 may involve the processor 412 receiving the first indication to select one or more sub-configurations via a DCI or a MAC-CE.

In some implementations, the process 500 may involve the processor 412 measuring the CSI-RS based on said one or more sub-configurations. The measuring of the CSI-RS associated with said one or more disabled antenna elements indicated in said one or more sub-configurations is not performed. The process 500 may involve the processor 412 generating the first measurement report of the CSI-RS according to a result of the measuring of the CSI-RS.

In some implementations, the list of sub-configurations comprises a specific sub-configuration which indicates that all antenna elements of the network apparatus are enabled. The process 500 may involve the processor 412 receiving the second indication to select the specific sub-configuration via the DCI or the MAC-CE and measuring the CSI-RS based on the specific sub-configuration. The measuring of the CSI-RS associated with all antenna elements are performed. The process 500 may involve the processor 412 generating the second measurement report of the CSI-RS according to a result of the measuring of the CSI-RS.

In some implementations, the process 500 may involve the processor 412 receiving the second indication to indicate an all-enabled status of the antenna elements via the DCI or the MAC-CE and measuring the CSI-RS based on the second indication. The measuring of the CSI-RS associated with all antenna elements are performed. The process 500 may involve the processor 412 generating the second measurement report of the CSI-RS according to a result of the measuring of the CSI-RS.

In some implementations, the process 500 may involve the processor 412 receiving the second indication to indicate an all-enabled status of the antenna elements via a paging signal, a PEI or a SIB-based signal, and measuring the CSI-RS based on the second indication. The measuring of the CSI-RS associated with all antenna elements are performed. The process 500 may involve the processor 412 generating the second measurement report of the CSI-RS according to a result of the measuring of the CSI-RS.

In some implementations, the process 500 may involve the processor 412 receiving a second configuration from the network apparatus 420. The second configuration may comprise information regarding a period or one or more occasions for enabling all antenna elements of the network apparatus, and the second indication is indicated with the second configuration. The process 500 may involve the processor 412 measuring the CSI-RS based on the second configuration and generating the second measurement report of the CSI-RS according to a result of the measuring of the CSI-RS. The measuring of the CSI-RS associated with all antenna elements are performed.

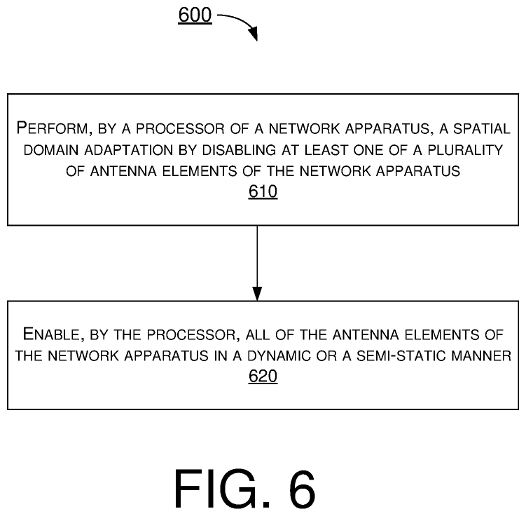

FIG. 6 depicting an example process 600 in accordance with an implementation of the present disclosure. The process 600 may be an example implementation of above scenarios/schemes, whether partially or completely, with respect to network power saving with spatial element adaptation with the present disclosure. The process 600 may represent an aspect of implementation of features of the network apparatus 420. The process 600 may include one or more operations, actions, or functions as illustrated by one or more of blocks 610 and 620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the network apparatus 420 or any suitable network device or network node. Solely for illustrative purposes and without limitation, the process 600 is described below in the context of the network apparatus 420. The process 600 may begin at block 610.

At 610, the process 600 may involve the processor 422 of the network apparatus 420 performing a spatial domain adaptation by disabling at least one of a plurality of antenna elements of the network apparatus 420. The process 600 may proceed from 610 to 620.

At 620, the process 600 may involve the processor 422 enabling all of the antenna elements of the network apparatus in a dynamic or a semi-static manner.

In some implementations, the process 600 may involve the processor 422 determining an enabled or disabled status of the antenna elements for one or more spatial adaptation patterns and transmitting a first configuration to the communication apparatus 410. The first configuration may comprise a list of sub-configurations, and each sub-configuration corresponds to one spatial adaptation pattern. The process 600 may involve the processor 422 transmitting a first indication to select one or more sub-configurations to the communication apparatus via a DCI or a MAC-CE.

In some implementations, the list of sub-configurations comprises a specific sub-configuration with a specific spatial adaptation pattern in which all of the antenna elements are enabled, and the process 600 may involve the processor 422 transmitting a second indication to select the specific sub-configuration to the communication apparatus via the DCI or the MAC-CE.

In some implementations, the process 600 may involve the processor 422 transmitting an indication to the communication apparatus 410 to indicate an all-enabled status of the antenna elements via the DCI or the MAC-CE.

In some implementations, the process 600 may involve the processor 422 transmitting an indication to the communication apparatus 410 to indicate an all-enabled status of the antenna elements via a paging signal, a PEI, or a SIB-based signal.

In some implementations, the process 600 may involve the processor 422 transmitting a second configuration to the communication apparatus 410. The second configuration comprises information regarding a period or one or more occasions to enable all of the antenna elements. The process 600 may involve the processor 422 performing a CSI-RS transmission based on the second configuration.

In some implementations, the process 600 may involve the processor receiving a measurement report of a CSI-RS from the communication apparatus 410 and determining whether to change an enabled or disabled status of the antenna elements of the spatial domain adaptation based on the measurement report.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a communication apparatus, a first measurement report of a channel state information-reference signal (CSI-RS) based on a first indication from a network apparatus; and
transmitting, by the processor, a second measurement report of the CSI-RS based on a second indication from the network apparatus,
wherein a number of antenna elements of the network apparatus associated with the first measurement report is less than a number of antenna elements of the network apparatus associated with the second measurement report.

2. The method of claim 1, further comprising:
receiving, by the processor, a first configuration from the network apparatus, wherein the first configuration comprises a list of sub-configurations, and wherein each sub-configuration indicates one or more enabled or disabled antenna elements of the network apparatus; and
receiving, by the processor, the first indication to select one or more sub-configurations via a downlink control information (DCI) or a media access control (MAC) control element (MAC-CE).

3. The method of claim 2, further comprising:
measuring, by the processor, the CSI-RS based on said one or more sub-configurations, wherein the measuring of the CSI-RS associated with said one or more disabled antenna elements indicated in said one or more sub-configurations is not performed; and
generating, by the processor, the first measurement report of the CSI-RS according to a result of the measuring of the CSI-RS.

4. The method of claim 2, wherein the list of sub-configurations comprises a specific sub-configuration which indicates that all antenna elements of the network apparatus are enabled, and wherein the method further comprises:
receiving, by the processor, the second indication to select the specific sub-configuration via the DCI or the MAC-CE;
measuring, by the processor, the CSI-RS based on the specific sub-configuration, wherein the measuring of the CSI-RS associated with all antenna elements are performed; and
generating, by the processor, the second measurement report of the CSI-RS according to a result of the measuring of the CSI-RS.

5. The method of claim 1, further comprising:
receiving, by the processor, the second indication to indicate an all-enabled status of the antenna elements via the DCI or the MAC-CE;
measuring, by the processor, the CSI-RS based on the second indication, wherein the measuring of the CSI-RS associated with all antenna elements are performed; and
generating, by the processor, the second measurement report of the CSI-RS according to a result of the measuring of the CSI-RS.

6. The method of claim 1, further comprising:
receiving, by the processor, the second indication to indicate an all-enabled status of the antenna elements via a paging signal, a paging early indication (PEI), or a system information block (SIB) based signal;
measuring, by the processor, the CSI-RS based on the second indication, wherein the measuring of the CSI-RS associated with all antenna elements are performed; and
generating, by the processor, the second measurement report of the CSI-RS according to a result of the measuring of the CSI-RS.

7. The method of claim 1, wherein further comprising:
receiving, by the processor, a second configuration from the network apparatus, wherein the second configuration comprises information regarding a period or one or more occasions for enabling all antenna elements of the network apparatus, and wherein the second indication is indicated with the second configuration;
measuring, by the processor, the CSI-RS based on the second configuration, wherein the measuring of the CSI-RS associated with all antenna elements are performed; and
generating, by the processor, the second measurement report of the CSI-RS according to a result of the measuring of the CSI-RS.

8. A communication apparatus, comprising:
a transceiver which, during operation, wirelessly communicates with at least one network apparatus; and
a processor communicatively coupled to the transceiver such that, during operation, the processor performs operations comprising:
transmitting, via the transceiver, a first measurement report of a channel state information-reference signal (CSI-RS) based on a first indication from the network apparatus; and
transmitting, via the transceiver, a second measurement report of the CSI-RS based on a second indication from the network apparatus,
wherein a number of antenna elements of the network apparatus associated with the first measurement report is less than a number of antenna elements of the network apparatus associated with the second measurement report.

9. The communication apparatus of claim 8, wherein, during operation, the processor further performs operations comprising:
receiving, via the transceiver, a first configuration from the network apparatus, wherein the first configuration comprises a list of sub-configurations, and wherein each sub-configuration indicates one or more enabled or disabled antenna elements of the network apparatus;
receiving, via the transceiver, the first indication to select one or more sub-configurations via a downlink control information (DCI) or a media access control (MAC) control element (MAC-CE);
measuring the CSI-RS based on said one or more sub-configurations, wherein the measuring of the CSI-RS associated with said one or more disabled antenna elements indicated in said one or more sub-configurations is not performed; and
generating the first measurement report of the CSI-RS according to a result of the measuring of the CSI-RS.

10. The communication apparatus of claim 9, wherein the list of sub-configurations comprises a specific sub-configuration which indicates that all antenna elements of the network apparatus are enabled, and wherein, during operation, the processor further performs operations comprising:
receiving, via the transceiver, the second indication to select the specific sub-configuration via the DCI or the MAC-CE;
measuring the CSI-RS based on the specific sub-configuration, wherein the measuring of the CSI-RS associated with all antenna elements are performed; and
generating the second measurement report of the CSI-RS according to a result of the measuring of the CSI-RS.

11. The communication apparatus of claim 8, wherein, during operation, the processor further performs operations comprising:
receiving, via the transceiver, the second indication to indicate an all-enabled status of the antenna elements via the DCI or the MAC-CE;
measuring the CSI-RS based on the second indication, wherein the measuring of the CSI-RS associated with all antenna elements are performed; and
generating the second measurement report of the CSI-RS according to a result of the measuring of the CSI-RS.

12. The communication apparatus of claim 8, wherein, during operation, the processor further performs operations comprising:
receiving, via the transceiver, the second indication to indicate an all-enabled status of the antenna elements via a paging signal, a paging early indication (PEI), or a system information block (SIB) based signal;
measuring the CSI-RS based on the second indication, wherein the measuring of the CSI-RS associated with all antenna elements are performed; and
generating the second measurement report of the CSI-RS according to a result of the measuring of the CSI-RS.

13. The communication apparatus of claim 8, wherein, during operation, the processor further performs operations comprising:
receiving, via the transceiver, a second configuration from the network apparatus, wherein the second configuration comprises information regarding a period or one or more occasions for enabling all antenna elements of the network apparatus, and wherein the second indication is indicated with the second configuration;
measuring the CSI-RS based on the second configuration, wherein the measuring of the CSI-RS associated with all antenna elements are performed; and
generating the second measurement report of the CSI-RS according to a result of the measuring of the CSI-RS.

14. A method, comprising:
performing, by a processor of a network apparatus, a spatial domain adaptation by disabling at least one of a plurality of antenna elements of the network apparatus; and
enabling, by the processor, all of the antenna elements of the network apparatus in a dynamic or a semi-static manner.

15. The method of claim 14, further comprising:
determining, by the processor, an enabled or disabled status of the antenna elements for one or more spatial adaptation patterns;
transmitting, by the processor, a first configuration to a communication apparatus, wherein the first configuration comprises a list of sub-configurations, and wherein each sub-configuration corresponds to one spatial adaptation pattern; and
transmitting, by the processor, a first indication to select one or more sub-configurations to the communication apparatus via a downlink control information (DCI) or a media access control (MAC) control element (MAC-CE).

16. The method of claim 15, wherein the list of sub-configurations comprises a specific sub-configuration with a specific spatial adaptation pattern in which all of the antenna elements are enabled, and wherein the method further comprises:
transmitting, by the processor, a second indication to select the specific sub-configuration to the communication apparatus via the DCI or the MAC-CE.

17. The method of claim 14, further comprising:
transmitting, by the processor, an indication to a communication apparatus to indicate an all-enabled status of the antenna elements via the DCI or the MAC-CE.

18. The method of claim 14, further comprising:
transmitting, by the processor, an indication to a communication apparatus to indicate an all-enabled status of the antenna elements via a paging signal, a paging early indication (PEI), or a system information block (SIB) based signal.

19. The method of claim 14, further comprising:
transmitting, by the processor, a second configuration to a communication apparatus, wherein the second configuration comprises information regarding a period or one or more occasions to enable all of the antenna elements; and
performing a channel state information-reference signal (CSI-RS) transmission based on the second configuration.

20. The method of claim 14, further comprising:
receiving, by the processor, a measurement report of a channel state information-reference signal (CSI-RS) from a communication apparatus; and
determining, by the processor, whether to change an enabled or disabled status of the antenna elements of the spatial domain adaptation based on the measurement report.
